(19) United States
(12) Patent Application Publication
(10) Pub. No.: US 2018/0293623 A1
(43) Pub. Date: Oct. 11, 2018

(54) INFORMATION PROVIDING DEVICE, SERVER, AND INFOMATION PROVIDING SYSTEM

(71) Applicant: TOYOTA JIDOSHA KABUSHIKI KAISHA, Toyota-shi, Aichi (JP)

(72) Inventors: Kenichi MURATA, Miyoshi-shi (JP); Yasuyuki TAMANE, Miyoshi-shi (JP); Masato ENDO, Nagakute-shi (JP)

(73) Assignee: TOYOTA JIDOSHA KABUSHIKI KAISHA, Toyota-shi, Aichi (JP)

(21) Appl. No.: 15/766,847

(22) PCT Filed: Dec. 5, 2016
(86) PCT No.: PCT/JP2016/086095

§ 371 Date: Apr. 9, 2018

(30) Foreign Application Priority Data
Dec. 17, 2015 (JP) 2015-246725

(51) Int. Cl. G06Q 30/02

(52) U.S. Cl. CPC G06Q 30/0266; G06Q 30/0281; G06Q 30/0259; G06Q 30/0261

(57) ABSTRACT

An information providing device configured to obtain positional information of one or more registered stores registered as a store of which an occupant of a vehicle wants to receive provision of information from a server; determine whether there exists at least one nearby store located in a vicinity of the vehicle among the registered stores, based on positional information of the vehicle and the positional information of the registered stores; obtain neighboring store information including at least one of crowdedness level, sale information, coupon information, and menu information of the nearby store determined as existing, from the server; and provide the occupant with the obtained neighboring store information and existence information with which the occupant is made aware of the existence of the nearby store.

### TECHNICAL FIELD

The present invention relates to an information providing device, a server, and an information providing system.

### BACKGROUND ART

Conventionally, an information providing device has been known that is installed in a vehicle and provides information to an occupant of the vehicle (see, for example, Patent Document 1). Such an information providing device obtains store information regarding stores in the vicinity of the vehicle, and selects a store to be presented to the occupant, based on the obtained store information, liking of the occupant regarding the stores, and the like. This technology attempts to narrow down suitable stores to be presented to the occupant from among the stores in the vicinity of the vehicle, and to automatically select and present required information for the occupant.

### RELATED-ART DOCUMENTS

### Patent Documents

[Patent Document 1] Japanese Unexamined Patent Application Publication No. 2006-184008

### SUMMARY OF THE INVENTION

### Problem to be Solved by Invention

The information providing device of the conventional technology mentioned above obtains store information regarding stores in the vicinity of the vehicle from a server installed at a place away from the vehicle, and then, narrows down suitable stores to be presented to the occupant from among the stores in the vicinity of the vehicle.

However, the stores in the vicinity of the vehicle are not necessarily exactly alike as stores of which the occupant of the vehicle wants to receive provision of information. Therefore, according to the above-mentioned conventional technology, information obtained by the information providing device from the server (corresponding to store information regarding stores in the vicinity of the vehicle in the case of the above-mentioned conventional technology) may include information regarding stores other than stores of which the occupant of the vehicle wants to receive provision of information. Therefore, the amount of information obtained by the information providing device from the server increases, and thereby, communication load between the information providing device and the server tends to increase easily.

Thereupon, the present invention has an object to inhibit increase of communication load between an information providing device and a server, and to provide an occupant of the vehicle with information regarding a nearby store located in the vicinity of the vehicle from among stores of which the occupant of a vehicle wants to receive provision of information.

### Means to Solve the Problem

In order to achieve the above object, according to an aspect of the present invention, an information providing device installed in a vehicle, and connectable to a server located at a place away from the vehicle by using a wireless communication channel, includes a vehicle positional information obtainer configured to obtain positional information of the vehicle; a store positional information obtainer configured to obtain positional information of one or more registered stores registered in the server as a store of which an occupant of the vehicle wants to receive provision of information, from the server by using the wireless communication channel; an existence determiner configured to determine whether there exists at least one nearby store located in a vicinity of the vehicle among the registered stores, based on the positional information of the vehicle obtained by the vehicle positional information obtainer, and the positional information of the registered stores obtained by the store positional information obtainer; a neighboring store information obtainer configured to obtain neighboring store information including at least one of crowdedness level, sale information, coupon information, and menu information of the nearby store determined as existing by the existence determiner, from the server by using the wireless communication channel; an existence information generator configured to generate existence information with which the occupant is made aware of the existence of the nearby store, based on the positional information of the nearby store; and an information provider configured to provide the occupant with the existence information generated by the existence information generator, and the neighboring store information obtained by the neighboring store information obtainer.

According to this aspect, the store positional information obtainer obtains positional information of one or more registered stores registered in the server as a store of which an occupant of the vehicle wants to receive provision of information, from the server by using the wireless communication channel. The existence determiner determines whether there exists at least one nearby store located in a vicinity of the vehicle among the registered stores. The neighboring store information obtainer obtains neighboring store information including at least one of crowdedness level, sale information, coupon information, and menu information of the nearby store determined as existing by the existence determiner, from the server by using the wireless communication channel.

Therefore, information that is obtained by the information providing device from the server (namely, in this aspect, positional information of the registered stores and the neighboring store information) is not information regarding stores other than stores of which the occupant of a vehicle wants to receive provision of information, but is narrowed down to information regarding stores of which the occupant of the vehicle wants to receive provision of information. Therefore, it is possible to inhibit inclusion of information regarding stores other than stores of which the occupant of the vehicle wants to receive provision of information, in the information that is obtained by the information providing device from the server. Therefore, increase in the amount of information that is obtained by the information providing device from the server is inhibited, and hence, it is possible to inhibit increase of communication load between the information providing device and the server.

Also, the information provider provides the occupant with the existence information generated by the existence information generator, and the neighboring store information obtained by the neighboring store information obtainer. Therefore, among stores of which the occupant of the vehicle wants to receive provision of information, it is possible to provide the occupant with information regarding a nearby store located in the vicinity of the vehicle (namely, in this aspect, the existence information and the neighboring store information). Consequently, it is possible to encourage the occupant to come to the nearby store.

According to another aspect of the present invention, a store registrator is further provided that is configured to receive a request for registration of a store of which the occupant wants to receive provision of information from the occupant, to register the store requested for the registration in the server by using the wireless communication channel.

According to this aspect, the information providing device installed in the vehicle includes the store registrator configured to receive a request for registration of a store of which the occupant wants to receive provision of information from the occupant, to register the store requested for the registration in the server by using the wireless communication channel. Therefore, it is possible for the occupant to register, in person, a store of which the occupant wants to receive provision of information from the vehicle into the remote server while riding in the vehicle.

According to yet another aspect of the present invention, a priority store designator is further provided that is configured to receive from the occupant a request for designation of a store of which the occupant wants to receive provision of information with priority, to designate the store requested for the designation as a priority store, wherein the information provider provides the occupant with information regarding the nearby store designated as the priority store, with a higher priority than with information regarding the nearby store not designated as the priority store.

According to this aspect, the priority store designator is configured to receive from the occupant a request for designation of a store of which the occupant wants to receive provision of information with priority, to designate the store requested for the designation as a priority store. Then, the information provider provides the occupant with information regarding the nearby store designated as the priority store, with a higher priority than with information regarding the nearby store not designated as the priority store. Therefore, it is possible for the occupant to designate, in person, a store of which the occupant wants to receive provision of information with priority while riding in the vehicle. Also, the occupant can receive provision of information regarding the nearby store designated as the priority store, with a higher priority than with information regarding the nearby store not designated as the priority store.

According to yet another aspect of the present invention, the neighboring store information includes the crowdedness level of the nearby store, and the information provider provides the occupant with information regarding the nearby store whose crowdedness level is lower, with a greater emphasis than with information regarding the nearby store whose crowdedness level is higher.

According to this aspect, provision of information regarding the nearby store whose crowdedness level is lower is emphasized more than provision of information regarding the nearby store whose crowdedness level is higher, and hence, it is possible to encourage the occupant for coming to the store to the nearby store with the lower crowdedness level. Moreover, since the occupant is less encouraged to come to the nearby store whose crowdedness level is higher, satisfaction of the occupant increases.

Also, in order to achieve the above object, according to yet another aspect of the present invention, a server located at a place away from a vehicle, and connectable to an information providing device installed in the vehicle, by using a wireless communication channel, includes a vehicle positional information obtainer configured to obtain positional information of the vehicle from the information providing device by using the wireless communication channel; a store positional information obtainer configured to obtain positional information of one or more registered stores registered in a user information storage of the server as a store of which an occupant of the vehicle wants to receive provision of information from a store information storage of the server by using the wireless communication channel; an existence determiner configured to determine whether there exists at least one nearby store located in a vicinity of the vehicle among the registered stores, based on the positional information of the vehicle obtained by the vehicle positional information obtainer, and the positional information of the registered stores obtained by the store positional information obtainer; a neighboring store information obtainer configured to obtain neighboring store information including at least one of crowdedness level, sale information, coupon information, and menu information of the nearby store determined as existing by the existence determiner, from the store information storage; an existence information generator configured to generate existence information with which the occupant is made aware of the existence of the nearby store, based on the positional information of the nearby store; and an information provider configured to transmit the existence information generated by the existence information generator, and the neighboring store information obtained by the neighboring store information obtainer by using the wireless communication channel, to provide the occupant with the existence information and the neighboring store information, via the information providing device.

According to this aspect, the store positional information obtainer obtains positional information of one or more registered stores registered in a user information storage of the server as a store of which an occupant of the vehicle wants to receive provision of information from a store information storage of the server. The existence determiner determines whether there exists at least one nearby store located in a vicinity of the vehicle among the registered stores. The neighboring store information obtainer obtains neighboring store information including at least one of crowdedness level, sale information, coupon information, and menu information of the nearby store determined as existing by the existence determiner, from the store information storage. The information provider transmits the existence information generated by the existence information generator, and the neighboring store information obtained by the neighboring store information obtainer by using the wireless communication channel, to provide the occupant with the existence information and the neighboring store information, via the information providing device.

Therefore, information that is obtained by the information providing device from the server (namely, in this aspect, the existence information and the neighboring store information) is not information regarding stores other than stores of which the occupant of a vehicle wants to receive provision of information, but is narrowed down to information regarding stores of which the occupant of the vehicle wants to receive provision of information. Therefore, it is possible to inhibit inclusion of information regarding stores other than stores of which the occupant of the vehicle wants to receive provision of information, in the information that is obtained by the information providing device from the server. Therefore, increase in the amount of information that is obtained by the information providing device from the server is inhibited, and hence, it is possible to inhibit increase of communication load between the information providing device and the server.

Also, the information provider transmits the existence information generated by the existence information generator, and the neighboring store information obtained by the neighboring store information obtainer by using the wireless communication channel, to provide the occupant with the existence information and the neighboring store information, via the information providing device. Therefore, among stores of which the occupant of the vehicle wants to receive provision of information, it is possible to provide the occupant with information regarding a nearby store located in the vicinity of the vehicle (namely, in this aspect, the existence information and the neighboring store information). Consequently, it is possible to encourage the occupant to come to the nearby store.

According to another aspect of the present invention, a store registrator is further provided that is configured to receive a request for registration of a store of which the occupant wants to receive provision of information by using the wireless communication channel by using the wireless communication channel, to register the store requested for the registration in the user information storage.

According to this aspect, the server located at the place away from the vehicle includes the store registrator configured to receive a request for registration of a store of which the occupant wants to receive provision of information by using the wireless communication channel by using the wireless communication channel, to register the store requested for the registration in the user information storage. Therefore, it is possible, from the vehicle side, to register the store of which the occupant wants to receive provision of information, into the server.

According to yet another aspect of the present invention, a priority store designator is further provided that is configured to receive a request for designation of a store of which the occupant wants to receive provision of information with priority by using the wireless communication channel, to designate the store requested for the designation as a priority store, wherein the information provider provides the occupant with information regarding the nearby store designated as the priority store, with a higher priority than with information regarding the nearby store not designated as the priority store, via the information providing device.

According to this aspect, the priority store designator receives from the occupant a request for designation of a store of which the occupant wants to receive provision of information with priority by using the wireless communication channel, to designate the store requested for the designation as a priority store. Then, the information provider provides the occupant with information regarding the nearby store designated as the priority store, with a higher priority than with information regarding the nearby store not designated as the priority store, via the information providing device. Therefore, it is possible, from the vehicle side, to designate the store of which the occupant wants to receive provision of information with priority. Also, the occupant can receive provision of information regarding the nearby store designated as the priority store, with a higher priority than with information regarding the nearby store not designated as the priority store.

According to yet another aspect of the present invention, the neighboring store information includes the crowdedness level of the nearby store, and the information provider provides the occupant with information regarding the nearby store whose crowdedness level is lower, with a greater emphasis than with information regarding the nearby store whose crowdedness level is higher, via the information providing device.

According to this aspect, provision of information regarding the nearby store whose crowdedness level is lower is emphasized more than provision of information regarding the nearby store whose crowdedness level is higher, and hence, it is possible to encourage the occupant for coming to the store to the nearby store with the lower crowdedness level. Moreover, since the occupant is less encouraged to come to the nearby store whose crowdedness level is higher, satisfaction of the occupant increases.

### Advantage of the Invention

According to an aspect of the present invention, it is possible to inhibit increase of communication load between an information providing device and a server, and to provide an occupant of the vehicle with information regarding a nearby store located in the vicinity of the vehicle from among stores of which the occupant of a vehicle wants to receive provision of information.

### BRIEF DESCRIPTION OF DRAWINGS

FIG. 1 is a diagram comprehensibly illustrating an example of a configuration of an information providing system;

FIG. 2 is a diagram comprehensibly illustrating an example of a hardware configuration of an information providing device;

FIG. 3 is a functional block diagram illustrating an example of functions of an information providing system according to a first embodiment;

FIG. 4 is a diagram schematically illustrating an example of personal information stored in a user information storage;

FIG. 5 is a diagram schematically illustrating an example of information stored in a store information storage;

FIG. 6 is a flowchart illustrating an example of a store registration process of registering stores of which the occupant wants to receive provision of information;

FIG. 7 is a flowchart illustrating an example of an information providing process of providing an occupant with information regarding nearby stores;

FIG. 8 is a flowchart illustrating an example of an order process of placing an order with a nearby store; and

FIG. 9 is a functional block diagram illustrating an example of functions of an information providing system according to a second embodiment.

### MODE FOR CARRYING OUT THE INVENTION

In the following, embodiments will be described with reference to the drawings.

### Embodiment of Information Providing System

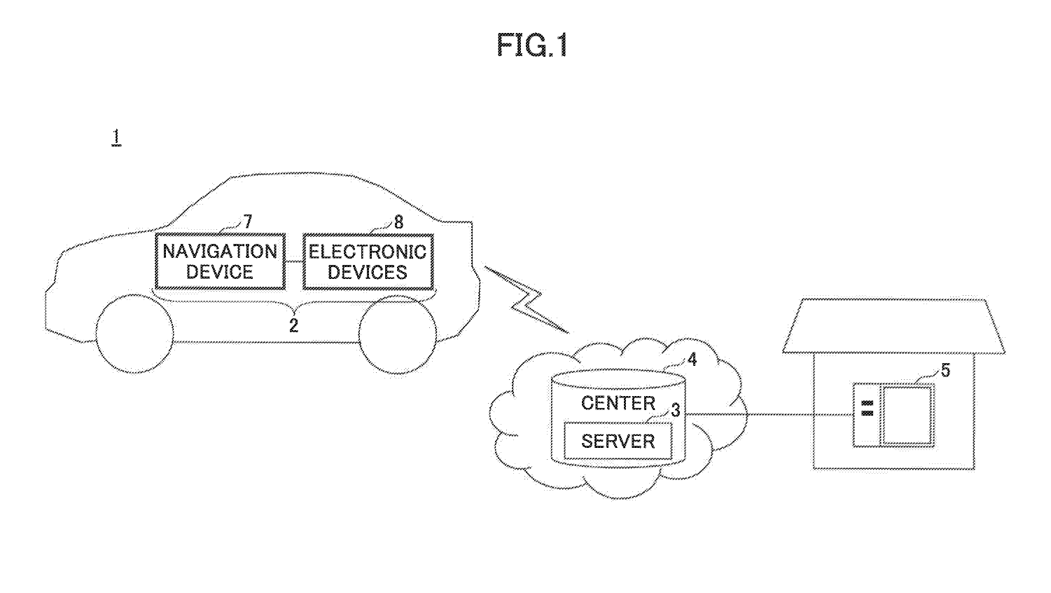

FIG. 1 is a configuration diagram comprehensibly illustrating an example of a configuration of an information providing system 1. The information providing system 1 is an example of a system that provides an occupant of a vehicle with information regarding a nearby store located in the vicinity of the vehicle among stores of which the occupant wants to receive provision of information. The information providing system 1 includes a server 3 located in a center 4, and an information providing device 2 installed in the vehicle.

The center 4 is a facility that exists at a place away from the vehicle having the information providing device 2 installed. The server 3 placed in the center 4 is connectable to the information providing device 2 by using a wireless communication channel. The server 3 is connectable to store terminal units 5 installed at respective stores by using a wired communication channel or a wireless communication channel. The store terminal unit 5 is a computer installed at a store, which is, for example, a personal computer, a tablet terminal, or a store server.

The information providing device 2 is assumed to be installed in each of the vehicles. In the following, unless noted otherwise, the information providing device 2 installed in one of the vehicles will be described. Also, in the following, unless noted otherwise, “the vehicle” represents a vehicle that has the information providing device 2 installed, and “the occupant” represents a person who rides in the vehicle.

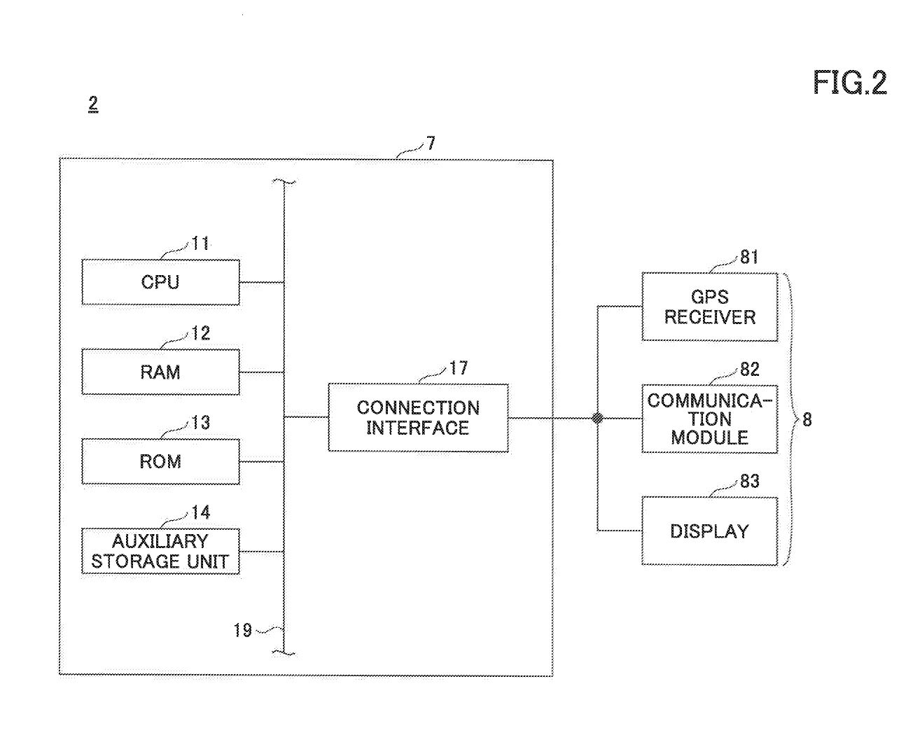

FIG. 2 is a diagram comprehensibly illustrating an example of a hardware configuration of the information providing device 2. The information providing device 2 is an example of an in-vehicle device that provides an occupant with information. The information providing device 2 includes a navigation device 7 and a group of electronic devices 8.

The navigation device 7 includes a CPU (Central Processing Unit) 11, a RAM (Random Access Memory) 12, a ROM (Read-Only Memory) 13, an auxiliary storage unit 14, and a connection interface 17, which are connected via a bus 19. The navigation device 7 is, for example, an ECU (Electronic Control Unit) equipped with a microcomputer that has the CPU 11, the RAM 12, and the ROM 13 built in. The navigation device 7 is connected with the group of electronic devices 8 through the connection interface 17.

The group of electronic devices 8 includes a GPS (Global Positioning System) receiver 81, a communication module 82, and a display 83.

The GPS receiver 81 is an example of a vehicle position detector that detects a current position of the vehicle, based on radio waves from GPS satellites.

The communication module 82 is an example of a communication apparatus for connecting the navigation device 7 of the information providing device 2 with the server 3 of the above center 4 through a wireless communication channel. The communication module 82 is a transceiver that can execute wireless communication by using, for example, a wireless communication channel for cellular phones.

The display 83 is an example of a display that provides an occupant with information. Specific examples of the display 83 may include a touch-sensitive liquid crystal display and a head-up display. The display 83 may be a display fixed in the vehicle, or may be a display of a mobile terminal device that can be brought into the vehicle (e.g., a smart phone, a tablet terminal, or a wearable terminal). In this case, communication between the mobile terminal device and the navigation device 7 is implemented, for example, by Bluetooth (registered trademark) through the connection interface 17.

Note that the information providing device 2 is not limited to a device installed in the vehicle in advance, and may be a mobile terminal device that has been brought into the vehicle (installed in the vehicle). The mobile terminal device can be carried by a user, and specific examples include, a smart phone, a tablet terminal, and a wearable terminal. The mobile terminal device that operates as the information providing device 2 also has substantially the same hardware configuration as in FIG. 2.

### First Embodiment

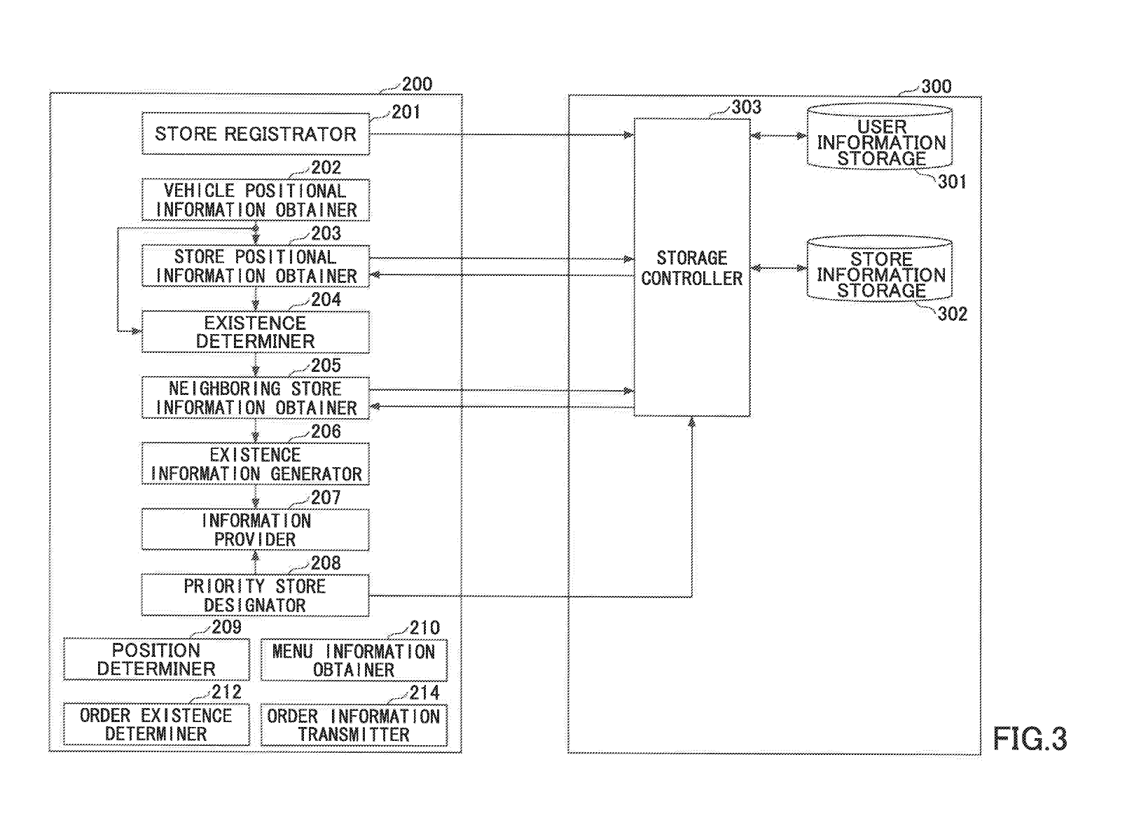

FIG. 3 is a functional block diagram illustrating an example of functions included in an information providing system according to the first embodiment. The information providing system illustrated in FIG. 3 is an example of the information providing system 1 illustrated in FIG. 1, and includes an information providing device 200 and a server 300. The information providing device 200 is an example of the information providing device 2 illustrated in FIGS. 1 and 2, and the server 300 is an example of the server 3 illustrated in FIG. 1.

In FIG. 3, the information providing device 200 includes a store registrator 201, a vehicle positional information obtainer 202, a store positional information obtainer 203, an existence determiner 204, a neighboring store information obtainer 205, an existence information generator 206, an information provider 207, a priority store designator 208, a position determiner 209, a menu information obtainer 210, an order existence determiner 212, and an order information transmitter 214. These functions are implemented by the CPU 11 in FIG. 2 that loads various programs stored in the ROM 13 on the RAM 12, and runs the programs.

Meanwhile, the server 300 has a storage controller 303, a user information storage 301, and a store information storage 302. Since the hardware configuration of the server 300 is substantially the same as the hardware configuration of the navigation device 7 illustrated in FIG. 2, the illustration is omitted. The storage controller 303 is implemented by a CPU in the server 300 that loads various programs stored in a ROM on a RAM, and runs the programs. The user information storage 301 and the store information storage 302 are implemented by one or more auxiliary storage units in the server 300.

The store registrator 201 is an example of a means of receiving from an occupant a request for registration of a store of which the occupant wants to receive provision of information, to register the store requested to be registered into the server 3 by using a wireless communication channel. Having the store registrator 201 included in the information providing device 200 installed in the vehicle enables the occupant to register, in person, a store of which the occupant wants to receive provision of information from the vehicle into the remote server 300 while riding in the vehicle.

The store registrator 201 receives from the occupant a request for registration of a store of which the occupant wants to receive provision of information, for example, by using a reception device installed in the vehicle. Specific examples of the reception device include a sound input device that collects the occupant's voice, and an input operation device (including a touch-sensitive display) that can be operated by the occupant manually.

For example, the store registrator 201 causes the communication module 82 (see FIG. 2) to wirelessly transmit a store ID (identification) assigned to a store requested to be registered by the occupant, and the user ID of the occupant to the server 300. Then, the store registrator 201 registers the store ID of the store requested to be registered by the occupant in the user information storage 301 under the corresponding user ID, through the storage controller 303 of the server 300. The store ID is identification information for identifying a store, and the user ID is identification information for identifying an occupant or an information providing device 200. The storage controller 303 receives the store ID and the user ID wirelessly transmitted by the store registrator 201, and records the received store ID as a registered store ID on the user information storage 301 under the corresponding user ID.

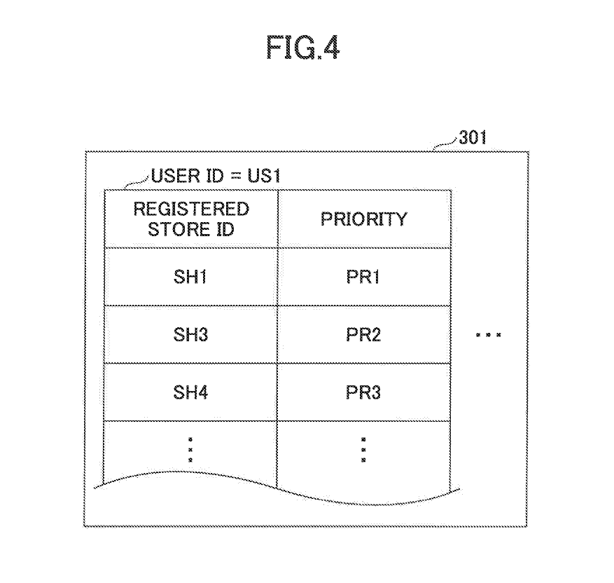

FIG. 4 is a diagram schematically illustrating an example of personal information stored in the user information storage 301. The storage controller 303 stores store IDs of registered stores registered as stores of which an occupant want to receive provision of information (registered store IDs) for each of the user IDs. FIG. 4 exemplifies that store IDs (SH1, SH3, and SH4) are registered in the user information storage 301 as registered store IDs under a user ID registered as US1.

In FIG. 3, the vehicle positional information obtainer 202 is an example of a means of obtaining positional information of the vehicle. The positional information of the vehicle is information for identifying the position of the vehicle (e.g., data of latitude and longitude). The vehicle positional information obtainer 202 obtains a current positional information of the vehicle, for example, from the GPS receiver 81 (see FIG. 2).

The store positional information obtainer 203 is an example of a means of obtaining positional information of a registered store registered in the server 300 as a store of which the occupant wants to receive provision of information, from the server 300 by using a wireless communication channel.

For example, the store positional information obtainer 203 wirelessly transmits the user ID of an occupant to the server 300 by the communication module 82 (see FIG. 2). Then, the store positional information obtainer 203 obtains the positional information of the registered store registered in the user information storage 301 as a store of which the occupant wants to receive provision of information, from the store information storage 302 of the server 300 through the storage controller 303. More specifically, the storage controller 303 receives the user ID wirelessly transmitted by the store positional information obtainer 203, and reads out a registered store ID that is registered under the same user ID as the received user ID from the user information storage 301. Then, the storage controller 303 reads out the positional information of the same store ID as the read-out registered store ID from the store information storage 302, and wirelessly transmits the read-out positional information to the store positional information obtainer 203.

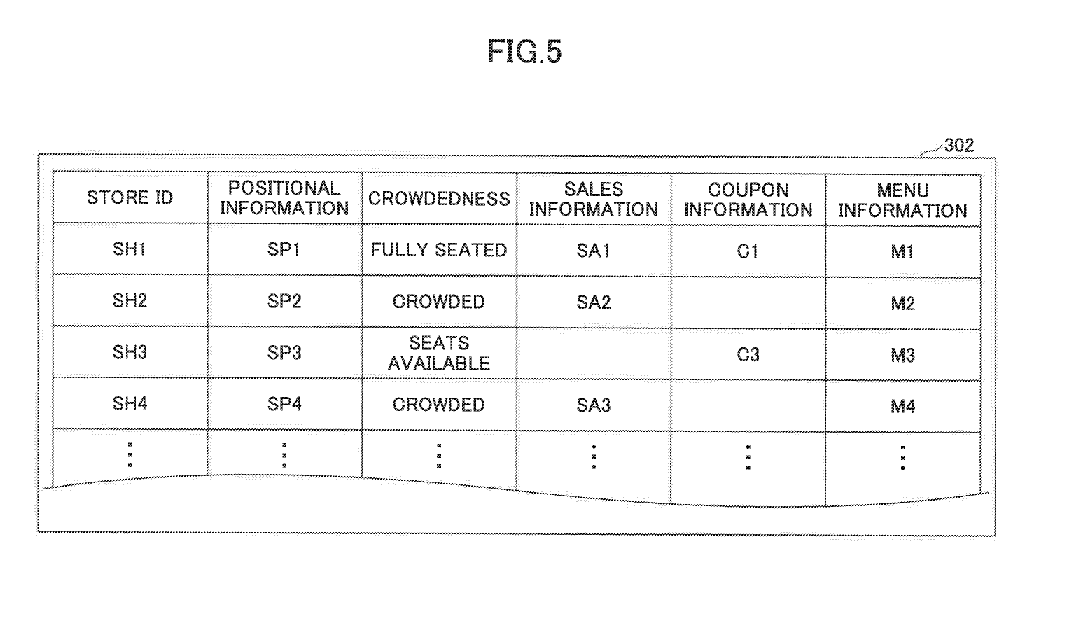

FIG. 5 is a diagram schematically illustrating an example of store information stored in the store information storage 302. FIG. 5 exemplifies that each of the store IDs (SH1, SH2, SH3, SH4, . . . ) of stores is associated with the positional information (SP1, SP2, SP3, SP4, . . . ) of each of the stores, to be stored in the store information storage 302. The positional information of a store is information for identifying the position of the store (e.g., data of latitude and longitude).

For example, the storage controller 303 receives a user ID (US1) wirelessly transmitted by the store positional information obtainer 203, and reads out registered store IDs (SH1, SH3, and SH4) registered under the same user ID as the received user ID from the user information storage 301 (see FIG. 4). Then, the storage controller 303 reads out the positional information of the same store IDs as the read registered store IDs (SH1, SH3, and SH4) from the store information storage 302 (see FIG. 5), and wirelessly transmits the read-out positional information to the store positional information obtainer 203.

In FIG. 3, the existence determiner 204 is an example of a means of determining, based on the positional information of the vehicle obtained by the vehicle positional information obtainer 202 and the positional information of registered stores obtained by the store positional information obtainer 203, whether there exists at least one store located near the vehicle among the obtained registered stores.

For example, the existence determiner 204 determines existence or nonexistence of a store located in the vicinity of the vehicle, by determining whether the position of a registered store exists within a predetermined radius centering on the position of the vehicle, based on the positional information of the vehicle and the registered stores. In this case, the existence determiner 204 sets a store that exists within the predetermined radius centering on the position of the vehicle as a nearby store among the registered stores.

Alternatively, for example, the existence determiner 204 may determine existence or nonexistence of a store located in the vicinity of the vehicle, by determining whether the position of a registered store exists on a guided route of the vehicle, and exists at a place that can be arrived within a predetermined arrival time, based on the positional information of the vehicle and the registered stores. The existence determiner 204 sets a store that exists on the guided route of the vehicle, and exists at the place that can be arrived within the predetermined arrival time, as a nearby store among the registered stores.

The neighboring store information obtainer 205 is an example of a means of obtaining neighboring store information including at least one of crowdedness level, sale information, coupon information, and menu information of the nearby store determined as existing by the existence determiner 204, from the server 300 by using a wireless communication channel.

For example, the neighboring store information obtainer 205 causes the communication module 82 (see FIG. 2) to wirelessly transmit the user ID of the occupant and the store ID of the nearby store to the server 300. The store ID of the nearby store has been obtained by the store positional information obtainer 203. Then, the neighboring store information obtainer 205 obtains the neighboring store information from the store information storage 302 of the server 300 through the storage controller 303. More specifically, the storage controller 303 receives the store ID of the nearby store wirelessly transmitted by the neighboring store information obtainer 205, and reads out business information including sale information stored under the same store ID as the store ID of the received nearby store, from the store information storage 302. Then, the storage controller 303 wirelessly transmits the business information read out from the store information storage 302 to the neighboring store information obtainer 205.

For example, FIG. 5 exemplifies that each of the store IDs (SH1, SH2, SH3, SH4, . . . ) is associated with the business information of each of the stores to be stored in the store information storage 302. The business information of a store is information representing contents of the business of the store, for example, at least one of information items of crowdedness level, sale information, coupon information, and menu information of the store.

The crowdedness level is information representing a level of crowdedness of a store. In the case of a store facilitated also with a drive-through, the crowdedness level includes not only the crowdedness level in the store but the crowdedness level of the drive-through. The crowdedness level can be represented by, for example, the number of waiting persons, waiting time, and the like. In FIG. 5, the crowdedness level eases off in the order of “fully seated”, “crowded”, and “seats available”.

The sale information is information that represents bargain information of a store. FIG. 5 exemplifies that sale information SA1, SA2, and SA3 are stored for the stores having the shop IDs of SH1, SH2, and SH4, respectively. The coupon information is information that represents a benefit of discount that can be received at a store. FIG. 5 exemplifies that coupon information C1 and C3 are stored for the stores having the shop IDs of SH1 and SH3, respectively. The menu information is information that represents contents of goods and/or services offered at a store. FIG. 5 exemplifies that menu information M1, M2, M3, and M4 are stored for the stores having the shop IDs of SH1, SH2, SH3, and SH4, respectively.

In FIG. 3, the existence information generator 206 is an example of a means of generating existence information with which the occupant is made aware of existence of a nearby store, based on positional information of the nearby store obtained by the store positional information obtainer 203. For example, the existence information generator 206 generates existence information with which the occupant is made aware of existence of an obtained nearby store, which may be, more specifically, a message such that “there is a store X 200 m ahead” to be displayed by the information provider 207.

The information provider 207 is an example of a means of providing the occupant with existence information generated by the existence information generator 206, and neighboring store information obtained by the neighboring store information obtainer 205. The information provider 207 provides the occupant with existence information and neighboring store information, for example, via the display 83 (see FIG. 2) and/or a speaker.

The priority store designator 208 is an example of a means of receiving from the occupant a request for designating a store of which the occupant wants to receive provision of information with priority, to designate the store requested for designation as a priority store. Having the priority store designator 208 included in the information providing device 200 installed in the vehicle enables the occupant to designate, in person, a store of which the occupant wants to receive provision of information with priority while riding in the vehicle. The priority store designator 208 receives such a request for designation from the occupant, for example, by using the reception device as in the case of the store registrator 201 described above.

For example, the priority store designator 208 causes the communication module 82 (see FIG. 2) to wirelessly transmit a store ID (identification) assigned to the store requested by the occupant for designation, and the user ID of the occupant to the server 300. Then, the priority store designator 208 registers the store ID of the store requested by the occupant for designation in the user information storage 301 under the corresponding user ID, via the storage controller 303 of the server 300. The storage controller 303 receives the store ID and the user ID wirelessly transmitted by the priority store designator 208, and records the priority of the received store ID on the user information storage 301 under the corresponding user ID. FIG. 4 exemplifies that priorities (PR1, PR2, and PR3) are associated with the respective registered store IDs, to be stored in the user information storage 301. The storage controller 303 includes the priority registered in the user information storage 301 in the neighboring store information, and wirelessly transmits the information to the neighboring store information obtainer 205.

The information provider 207 provides the occupant with information regarding a nearby store designated as a priority store by the priority store designator 208, with a higher priority than with information regarding a nearby store not designated as a priority store. This enables the occupant to receive information regarding a nearby store designated as a priority store, with a higher priority than with information regarding a nearby store not designated as a priority store.

Next, an example of operations of the information providing system according to the first embodiment will be described.

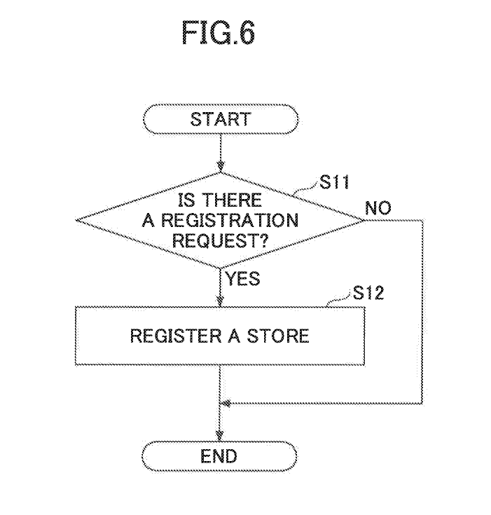

FIG. 6 is a flowchart illustrating an example of a store registration process of registering a store of which an occupant wants to receive provision of information.

At Step S11, the store registrator 201 determines whether there is a request for registration of a store of which the occupant wants to receive provision of information. If having determined that there is no request for registration, the store registrator 201 terminates this process. On the other hand, if having determined that there is a request for registration, the store registrator 201 registers the store requested for registration in the user information storage 301 (Step S12), and terminates this process.

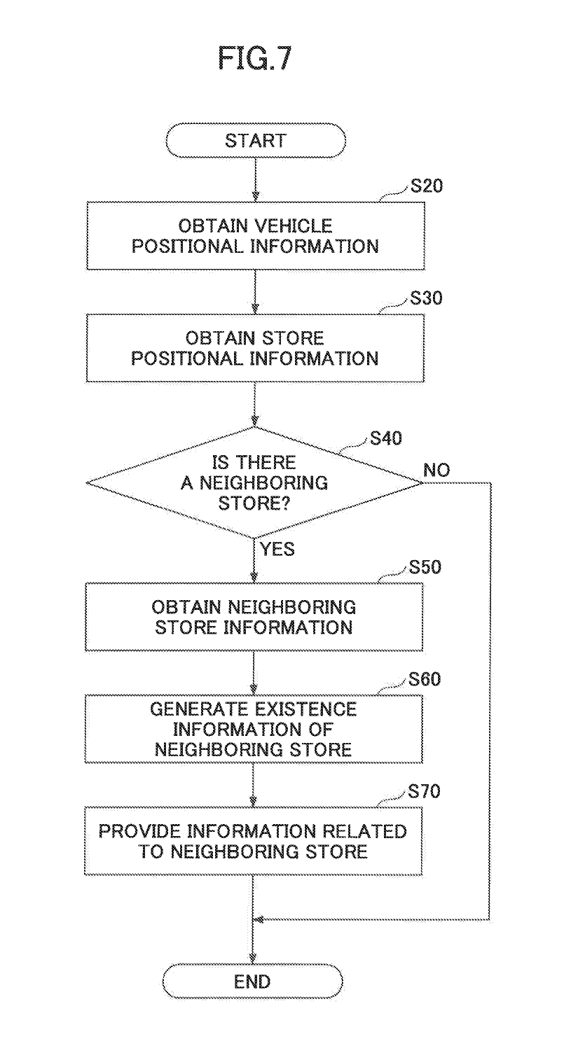

FIG. 7 is a flowchart illustrating an example of an information providing process of providing the occupant with information regarding nearby stores.

At Step S20, the vehicle positional information obtainer 202 obtains the positional information of the vehicle.

At Step S30, the store positional information obtainer 203 obtains positional information of registered stores registered in the server 300 as stores of which the occupant of the vehicle wants to receive provision of information, from the server 300 by using a wireless communication channel.

At Step S40, based on the positional information of the vehicle obtained by the vehicle positional information obtainer 202, and the positional information of the registered stores obtained by the store positional information obtainer 203, the existence determiner 204 determines whether there exists at least one store located in the vicinity of the vehicle among the registered stores. If having determined that there exists no store located in the vicinity of the vehicle among the registered stores, the existence determiner 204 terminates this process. On the other hand, if having determined that there is a store located in the vicinity of the vehicle among the registered stores, the existence determiner 204 executes a process of Step S50.

At Step S50, if having determined at Step S40 that there is a store located in the vicinity of the vehicle among the registered stores, the neighboring store information obtainer 205 obtains neighboring store information that includes at least one of crowdedness level, sale information, coupon information, and menu information of the nearby store determined as existing in the vicinity of the vehicle, from the server 300 by using a wireless communication channel.

Having the menu information obtained at Step S50 enables the information provider 70 to inform the occupant of contents of goods and/or services offered at the nearby store before arriving at the nearby store, which is executed at Step S70 as will be described below. Therefore, before the vehicle arrives at the nearby store, the occupant can examine the contents of goods and/or services.

Also, if the neighboring store information of all nearby stores determined as existing by the existence determiner 204 is obtained at Step S50, communication load from the server 300 to the information providing device 200 becomes high. Thereupon, the neighboring store information obtainer 205 may obtain at Step S50 neighboring store information only for stores designated as priority stores among the stores determined as existing by the existence determiner 204.

At Step S60, based on the positional information of the nearby stores obtained by the store positional information obtainer 203, the existence information generator 206 generates existence information with which the occupant is made aware of the existence of the nearby stores.

At Step S70, the information provider 207 provides the occupant with the existence information generated by the existence information generator 206, and the neighboring store information obtained by the neighboring store information obtainer 205.

Therefore, information that is obtained by the information providing device 200 from the server 300 (namely, in the first embodiment, positional information of registered stores obtained at Step S30 and neighboring store information obtained at and Step S50) is not information regarding stores other than stores of which the occupant of a vehicle wants to receive provision of information, but is narrowed down to information regarding stores of which the occupant of the vehicle wants to receive provision of information. Therefore, it is possible to inhibit inclusion of information regarding stores other than stores of which the occupant of the vehicle wants to receive provision of information, in the information that is obtained by the information providing device 200 from the server 300. Therefore, increase in the amount of information that is obtained by the information providing device 200 from the server 300 is inhibited, and hence, it is possible to inhibit increase of communication load between the information providing device 200 and the server 300.

Also, among stores of which the occupant of the vehicle wants to receive provision of information, it is possible to provide the occupant with information regarding a nearby store located in the vicinity of the vehicle (namely, in the first embodiment, existence information generated at Step S60 and neighboring store information obtained at Step S50). Consequently, it is possible to encourage the occupant to come to the nearby store.

Also, at Step S70, the information provider 207 provides the occupant, for example, with information regarding a nearby store designated as a priority store, with a higher priority than with information regarding a nearby store not designated as a priority store. This enables the occupant to receive provision of information regarding a nearby store designated as a priority store, with a higher priority than with provision of information regarding a nearby store not designated as a priority store. For example, the information provider 207 provides information regarding a nearby store designated as a priority store by sound, and provides information regarding a nearby store not designated as a priority store not by sound, but by a message display. Thereby, it is possible to reduce troublesomeness of providing the entire neighboring store information of all nearby stores determined as existing by the existence determiner 204 by sound.

Also, if crowdedness levels of nearby stores are included in neighboring store information obtained at Step S50, the information provider 207 provides at Step S70 the occupant, for example, with information regarding a nearby store whose crowdedness level is lower, with a greater emphasis than with information regarding a nearby store whose crowdedness level is higher. Thereby, provision of information regarding the nearby store whose crowdedness level is lower is emphasized more than provision of information regarding the nearby store whose crowdedness level is higher, and hence, it is possible to encourage the occupant for coming to the store to the nearby store with the lower crowdedness level. Moreover, since the occupant is less encouraged to come to a nearby store having a high crowdedness level, satisfaction of the occupant increases.

For example, the information provider 207 may stop providing information regarding a nearby store being crowded over a predetermined crowdedness level so as to prevent satisfaction of the occupant from declining due to guidance to a crowded store.

Also, for example, the information provider 207 compares the crowdedness level inside of a nearby store with the crowdedness level of the drive-through of the same store, to provide information that encourages the occupant to come to one of these being less crowded. This enables to prevent satisfaction of the occupant from declining due to provision of information that would encourage to come to one of these being more crowded.

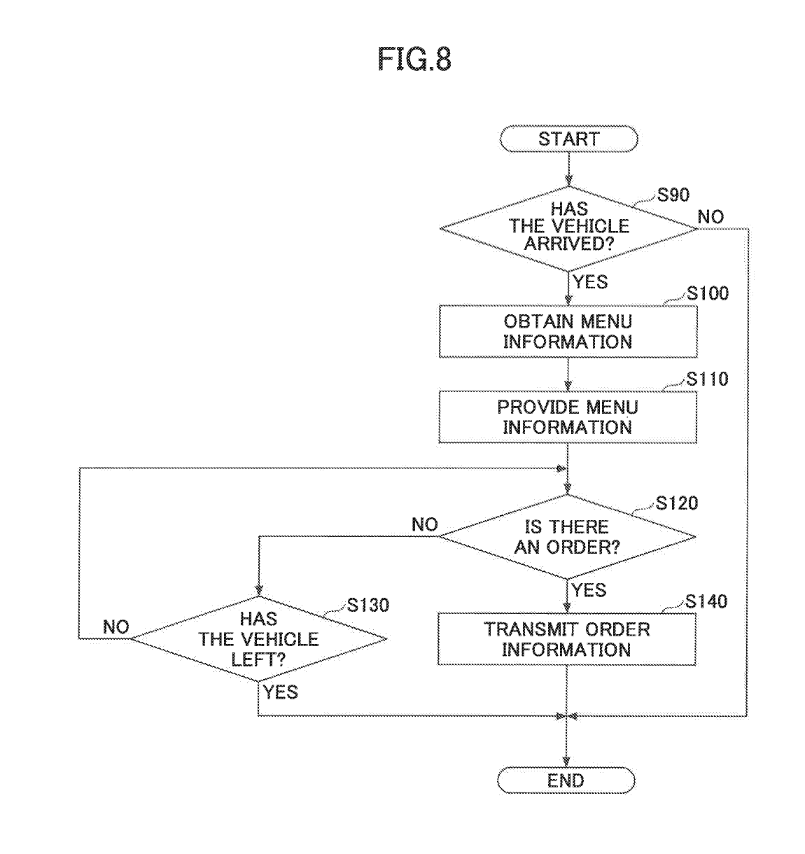

FIG. 8 is a flowchart illustrating an example of an order process of placing an order with a nearby store.

Based on positional information of a nearby store determined as existing by the existence determiner 204 and positional information of the vehicle, the position determiner 209 determines whether the vehicle has arrived at the nearby store. If having determined that the vehicle has not arrived at the nearby store, the position determiner 209 terminates this process. On the other hand, if having determined that the vehicle has arrived at the nearby store, the position determiner 209 executes a process of Step S100.

Also, for example, it is suitable at Step S90 that the position determiner 209 determines whether the vehicle enters the drive-through area or enters a parking lot in the site of the nearby store, and once having determined that the vehicle has entered the drive-through area, executes a process of Step S100. In a situation where the vehicle has entered the parking lot, it is expected that the occupant is going to enter the store on foot and to place an order. Therefore, when the vehicle has entered the parking lot, it is possible to reduce troublesomeness that would be felt by the occupant due menu display at Step S110 and an order reception process at Step S120.

At Step S100, if not having obtained menu information at Step S50 in FIG. 7, the menu information obtainer 210 obtains menu information of the nearby store at which the vehicle has arrived from the store information storage 302 of the server 300 by using a wireless communication channel. Note that if the menu information has already been obtained at Step S50 in FIG. 7, Step S100 is skipped.

At Step S110, the information provider 207 provides the occupant with the menu information obtained at Step S50 or Step S100. This enables to automatically provide the occupant with the menu information when the vehicle has arrived at the nearby store, and the occupant can smoothly use the informational service executed by the information providing system according to the embodiment.

At Step S120, the order existence determiner 212 determines whether there is an order request from the occupant. If having determined that there is an order request, the order existence determiner 212 wirelessly transmits order information that represents the content of the order request to the store terminal unit 5 (see FIG. 1) of the nearby store at which the vehicle has arrived (Step S140), and terminates this process. On the other hand, if having determined that there is no order request, the order existence determiner 212 executes a process of Step S130.

At Step S130, based on positional information of the vehicle and the nearby store, the position determiner 209 determines whether the vehicle has left the nearby store. If the position determiner 209 has determined that the vehicle has not left the nearby store, a process of Step S120 is executed again. On the other hand, if the position determiner 209 has determined that the vehicle has left the nearby store, this process ends.

### Second Embodiment

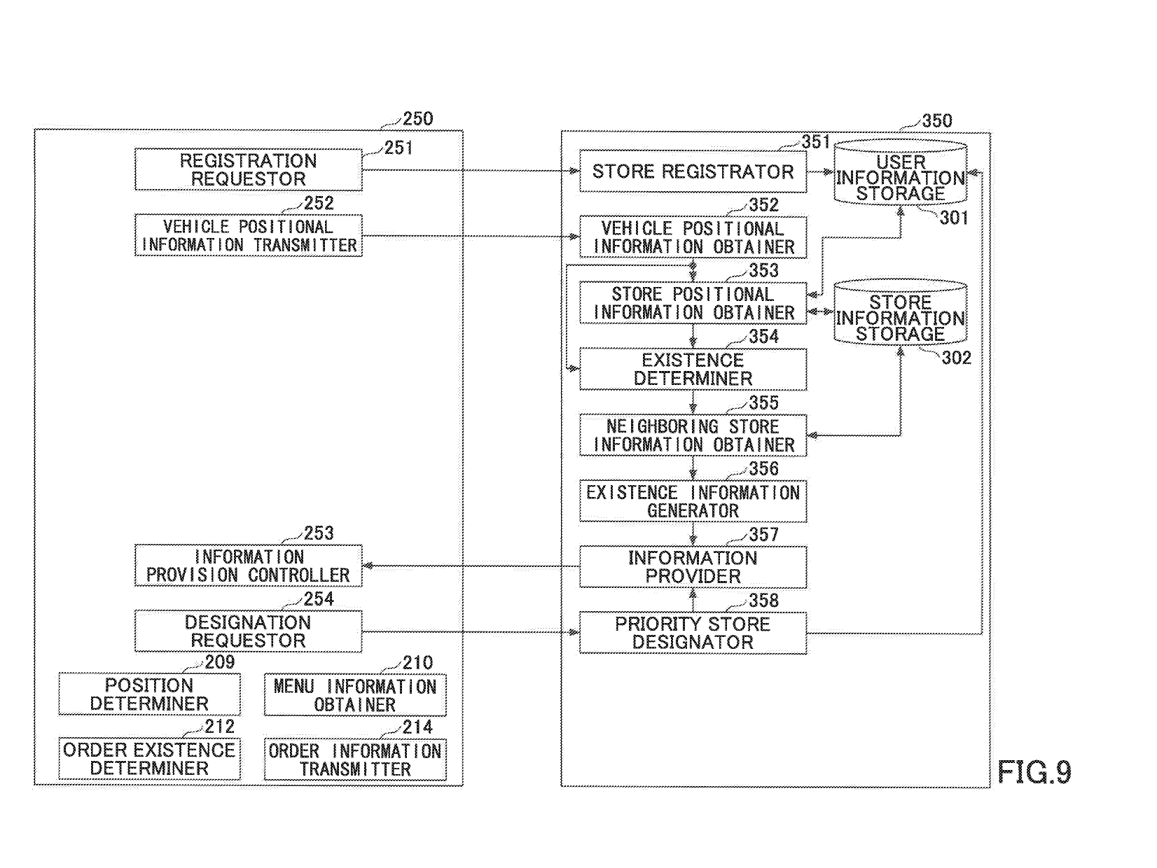

FIG. 9 is a functional block diagram illustrating an example of functions included in an information providing system according to a second embodiment. The information providing system illustrated in FIG. 9 is an example of the information providing system 1 illustrated in FIG. 1, and includes an information providing device 250 and a server 350. The information providing device 250 is an example of the information providing device 2 illustrated in FIGS. 1 and 2, and the server 350 is an example of the server 3 illustrated in FIG. 1. In the second embodiment, for substantially the same elements and effects as in the first embodiment, the description in the first embodiment may be referred to, so that duplication will be omitted or simplified in the following.

In FIG. 9, the information providing device 250 includes a registration requestor 251, a vehicle positional information transmitter 252, an information provision controller 253, a designation requestor 254, a position determiner 209, a menu information obtainer 210, an order existence determiner 212, and an order information transmitter 214. These functions are implemented by the CPU 11 in FIG. 2 that loads various programs stored in the ROM 13 on the RAM 12, and runs the programs.

Meanwhile, the server 350 includes a store registrator 351, a vehicle positional information obtainer 352, a store positional information obtainer 353, an existence determiner 354, a neighboring store information obtainer 355, an existence information generator 356, an information provider 357, a priority store designator 358, a user information storage 301, and a store information storage 302. These functions are implemented by a CPU in the server 350 that loads various programs stored in a ROM on a RAM, and runs the programs. The user information storage 301 and the store information storage 302 are implemented by one or more auxiliary storage units in the server 350. Note that since the hardware configuration of the server 350 is substantially the same as the hardware configuration of the navigation device 7 illustrated in FIG. 2, the illustration is omitted.

The store registrator 351 is an example of a means of receiving from an occupant a request for registration of a store of which the occupant wants to receive provision of information by using a wireless communication channel, to register the store requested to be registered in the user information storage 301 under the corresponding user ID. Having the store registrator 351 included in the server 350 located at a place away from vehicles enables, from each vehicle side, to register stores of which an occupant of the vehicle wants to receive provision of information, into the remote server 350 away from the vehicle.

The store registrator 351 obtains a request for registration of a store of which the occupant of each vehicle wants to receive provision of information from the registration requestor 251 by using a wireless communication channel. The registration requestor 251 is provided for wirelessly transmitting a request for registration of a store of which the occupant of the vehicle wants to receive provision of information to the server 350, and has substantially the same functions as the store registrator 201 (see FIG. 3). The store registrator 351 receives a store ID and a user ID wirelessly transmitted by the registration requestor 251, and records them on the user information storage 301 under the corresponding user ID, by setting the received store ID as a registered store ID.

In FIG. 9, the vehicle positional information obtainer 352 is an example of a means of obtaining positional information of each vehicle from the information providing device 250 of the vehicle by using a wireless communication channel. The vehicle positional information obtainer 352 obtains, for example, a current position information of each vehicle from the vehicle positional information transmitter 252 of the vehicle by using a wireless communication channel. The vehicle positional information transmitter 252 causes the communication module 82 (see FIG. 2) to wirelessly transmit the current position information of the vehicle obtained from the GPS receiver 81 (see FIG. 1) of the vehicle to the server 350.

In FIG. 9, the store positional information obtainer 353 is an example of a means of obtaining positional information of a registered store registered in the user information storage 301 of the server 350 as a store of which the occupant of the vehicle wants to receive provision of information from the store information storage 302 of the server 350.

For example, the store positional information obtainer 353 receives the user ID that the vehicle positional information transmitter 252 caused the communication module 82 (see FIG. 2) to wirelessly transmit, and reads out the registered store ID registered under the same user ID as the received user ID from the user information storage 301 (see FIG. 4). Then, the store positional information obtainer 353 reads out the positional information of the same store ID as the read-out registered store ID from the store information storage 302 (see FIG. 5), to obtain the positional information of the registered store of which the occupant corresponding to the received user ID wants to receive provision of information.

In FIG. 9, the existence determiner 354 is an example of a means of determining whether there exists at least one store located near the vehicle whose positional information has been obtained by the vehicle positional information obtainer 352 among obtained registered stores, based on the positional information of the vehicle obtained by the vehicle positional information obtainer 352 and the positional information of registered stores obtained by the store positional information obtainer 203.

For example, the existence determiner 354 determines existence or nonexistence of a store located in the vicinity of the vehicle, by determining whether the position of a registered store exists within a predetermined radius centering on the position of the vehicle, based on the positional information of the vehicle and the registered stores. In this case, the existence determiner 354 sets a store that exists within the predetermined radius centering on the position of the vehicle as a nearby store among the registered stores.

Alternatively, for example, the existence determiner 354 may determine existence or nonexistence of a store located in the vicinity of the vehicle, by determining whether the position of a registered store exists on a guided route of the vehicle, and exists at a place that can be arrived within a predetermined arrival time, based on the positional information of the vehicle and the registered stores. In this case, the existence determiner 204 sets a store that exists on the guided route of the vehicle, and exists at the place that can be arrived within the predetermined arrival time, as a nearby store among the registered stores. Information of the guide route of the vehicle is wirelessly transmitted, for example, by the vehicle positional information transmitter 252.

The neighboring store information obtainer 355 is an example of a means of obtaining neighboring store information including at least one of crowdedness level, sale information, coupon information, and menu information of the nearby store determined as existing by the existence determiner 354, from the store information storage 302 of the server 350.

For example, the neighboring store information obtainer 355 reads out business information including sale information stored under the same store ID as the store ID of the nearby store read out by the store positional information obtainer 353 from the user information storage 301, from the store information storage 302 (see FIG. 5). This enables to obtain neighboring store information corresponding to the user ID transmitted by the vehicle positional information transmitter 252 of the information providing device 250 (neighboring store information related to a store located in the vicinity of the vehicle whose positional information has been obtained by the vehicle positional information obtainer 352).

In FIG. 9, the existence information generator 356 is an example of a means of generating existence information with which the occupant is made aware of existence of a nearby store, based on positional information of the nearby store obtained by the store positional information obtainer 353. For example, the existence information generator 356 generates existence information with which the occupant is made aware of existence of an obtained nearby store, which may be, more specifically, a message such that “there is a store X 200 m ahead” to be displayed by the information provider 357.

The information provider 357 is an example of a means of providing the occupant with existence information generated by the existence information generator 356, and neighboring store information obtained by the neighboring store information obtainer 355 via the information provision controller 253 of the information providing device 250. The information provision controller 253 receives the existence information generated by the existence information generator 356, and the neighboring store information obtained by the neighboring store information obtainer 355, to provide the occupant with the received existence information and neighboring store information through the display 83 (see FIG. 2) and/or a speaker.

The priority store designator 358 is an example of a means of receiving from the occupant a request for designating a store of which the occupant wants to receive provision of information with priority by using a wireless communication channel, to designate the store requested for designation as a priority store. Having the priority store designator 358 included in the server 350 located at a place away from vehicles enables, from each vehicle side, to register stores of which an occupant of the vehicle wants to receive provision of information with priority.

The priority store designator 358 receives from the occupant of each vehicle a request for registration of a store of which the occupant wants to receive provision of information with priority, from the designation requestor 254 by using a wireless communication channel. The designation requestor 254 is provided for wirelessly transmitting a request for registration of a store of which the occupant of the vehicle wants to receive provision of information with priority to the server 350, and has substantially the same functions as the priority store designator 208 (see FIG. 3). The priority store designator 358 receives the store ID and the user ID wirelessly transmitted by the designation requestor 254, and records the priority of the received store ID on the user information storage 301 under the corresponding user ID.

The information provider 357 provides the occupant with information regarding a nearby store designated as a priority store by the priority store designator 358, with a higher priority than with information regarding a nearby store not designated as a priority store, via the information provision controller 253 of the information providing device 250. This enables the occupant of each vehicle to receive information regarding a nearby store designated as a priority store, with a higher priority than with information regarding a nearby store not designated as a priority store.

Note that as for operations of the information providing system according to the second embodiment, the above description on the operations of the information providing system according to the first embodiment may be referred to, and detailed description on the operations of the information providing system according to the second embodiment is omitted.

Operations of the information providing system according to the second embodiment in FIG. 9 can also be described with reference to the flowcharts illustrated in FIGS. 6, 7, and 8. The store registrator 351 executes processes of Step S11 and Step S12 in FIG. 6. The vehicle positional information obtainer 352, the store positional information obtainer 353, the existence determiner 354, the neighboring store information obtainer 355, the existence information generator 356, and the information provider 357 execute processes of Step S20, Step S30, Step S40, Step S50, Step S60, and Step S70 in FIG. 7, respectively. The contents of the processes in FIG. 8 are the same in the second embodiment as in the first embodiment.

As above, an information providing device, a server, and an information providing system have been described with the embodiments. Note that the present invention is not limited to the above embodiments. Various modifications and improvements can be made within the scope of the present invention, by combining and/or replacing a part of or all of the embodiments with the others.

The present international application is based on Japanese Priority Application No. 2015-246725, filed on Dec. 17, 2015, and the entire contents of Japanese Priority Application No. 2015-246725 are hereby incorporated by reference.

### DESCRIPTION OF REFERENCE SYMBOLS

1 information providing system

2, 200, 250 information providing device

3, 300, 350 server

4 center

5 store terminal unit

7 navigation device

8 group of electronic devices

201 store registrator

202 vehicle positional information obtainer

203 store positional information obtainer

204 existence determiner

205 neighboring store information obtainer

206 existence information generator

207 information provider

208 priority store designator

301 user information storage

302 store information storage

351 store registrator

352 vehicle positional information obtainer

353 store positional information obtainer

354 existence determiner

355 neighboring store information obtainer

356 existence information generator

357 information provider

358 priority store designator

1. An information providing device installed in a vehicle, and connectable to a server located at a place away from the vehicle by using a wireless communication channel, the information providing device comprising:
a vehicle positional information obtainer configured to obtain positional information of the vehicle;
a store positional information obtainer configured to obtain positional information of one or more registered stores registered in the server as a store of which an occupant of the vehicle wants to receive provision of information, from the server by using the wireless communication channel;
an existence determiner configured to determine whether there exists at least one nearby store located in a vicinity of the vehicle among the registered stores, based on the positional information of the vehicle obtained by the vehicle positional information obtainer, and the positional information of the registered stores obtained by the store positional information obtainer;
a neighboring store information obtainer configured to obtain neighboring store information including at least one of crowdedness level, sale information, coupon information, and menu information of the nearby store determined as existing by the existence determiner, from the server by using the wireless communication channel;
an existence information generator configured to generate existence information with which the occupant is made aware of the existence of the nearby store, based on the positional information of the nearby store; and
an information provider configured to provide the occupant with the existence information generated by the existence information generator, and the neighboring store information obtained by the neighboring store information obtainer.

2. The information providing device as claimed in claim 1, further comprising:
a store registrator configured to receive from the occupant a request for registration of a store of which the occupant wants to receive provision of information, to register the store requested for the registration in the server by using the wireless communication channel.

3. The information providing device as claimed in claim 1, further comprising:
a priority store designator configured to receive from the occupant a request for designation of a store of which the occupant wants to receive provision of information with priority, to designate the store requested for the designation as a priority store,
wherein the information provider provides the occupant with information regarding the nearby store designated as the priority store, with a higher priority than with information regarding the nearby store not designated as the priority store.

4. The information providing device as claimed in claim 1, wherein the neighboring store information includes the crowdedness level of the nearby store, and the information provider provides the occupant with information regarding the nearby store whose crowdedness level is lower, with a greater emphasis than with information regarding the nearby store whose crowdedness level is higher.

5. An information providing system comprising:
one or more of the information providing devices as claimed in claim 1, and the server.

6. A server located at a place away from a vehicle, and connectable to an information providing device installed in the vehicle, by using a wireless communication channel, the server comprising:
a vehicle positional information obtainer configured to obtain positional information of the vehicle from the information providing device by using the wireless communication channel;
a store positional information obtainer configured to obtain positional information of one or more registered stores registered in a user information storage of the server as a store of which an occupant of the vehicle wants to receive provision of information from a store information storage of the server by using the wireless communication channel;
an existence determiner configured to determine whether there exists at least one nearby store located in a vicinity of the vehicle among the registered stores, based on the positional information of the vehicle obtained by the vehicle positional information obtainer, and the positional information of the registered stores obtained by the store positional information obtainer;
a neighboring store information obtainer configured to obtain neighboring store information including at least one of crowdedness level, sale information, coupon information, and menu information of the nearby store determined as existing by the existence determiner, from the store information storage;
an existence information generator configured to generate existence information with which the occupant is made aware of the existence of the nearby store, based on the positional information of the nearby store; and
an information provider configured to transmit the existence information generated by the existence information generator, and the neighboring store information obtained by the neighboring store information obtainer by using the wireless communication channel, to provide the occupant with the existence information and the neighboring store information, via the information providing device.

7. The server in claim 6, further comprising:
a store registrator configured to receive a request for registration of a store of which the occupant wants to receive provision of information by using the wireless communication channel, to register the store requested for the registration in the user information storage.

8. The server in claim 6, further comprising:
a priority store designator configured to receive a request for designation of a store of which the occupant wants to receive provision of information with priority by using the wireless communication channel, to designate the store requested for the designation as a priority store,
wherein the information provider provides the occupant with information regarding the nearby store designated as the priority store, with a higher priority than with information regarding the nearby store not designated as the priority store, via the information providing device.

9. The server in claim 6, wherein the neighboring store information includes the crowdedness level of the nearby store, and the information provider provides the occupant with information regarding the nearby store whose crowdedness level is lower, with a greater emphasis than with information regarding the nearby store whose crowdedness level is higher, via the information providing device.

10. An information providing system comprising:
the server as claimed in claim 6, and one or more of the information providing devices.
